(19) United States
(12) Patent Application Publication
(10) Pub. No.: US 2017/0030842 A1
(43) Pub. Date: Feb. 2, 2017

(54) DEVICE AND METHOD FOR OPTICALLY INSPECTING AND ANALYZING STENT-LIKE OBJECTS

(71) Applicant: Sensofar Medical, S.L., Terrassa (ES)

(72) Inventors: Ferran LAGUARTA BERTRAN, (US); Carlos Bermudez Porras, Navas (ES); Roger Artigas Pursals, Santa Eulalia De Roncana (ES); Cristina Cadevall Artigues, Terrassa (ES)

(21) Appl. No.: 15/105,479

(22) PCT Filed: Dec. 27, 2013
(86) PCT No.: PCT/EP2013/078085

§ 371 Date: Jun. 16, 2016

(51) Int. Cl. G01N 21/952; G01B 11/06; G01B 11/24; G01N 21/954

(52) U.S. Cl. CPC G01N 21/952; G01N 21/954; G01B 11/0675; G01B 11/2408; G01N 2201/062; G01N 2201/101; G01N 2201/104

(57) ABSTRACT

The device has an apparatus for rotatably holding and positioning at least one stent-like object and a unit for illuminating at least inner and outer surfaces thereof, including at least a wide field epi illumination device and a diffuse back illumination device for simultaneously illuminating the stent-like object. The illumination unit may further include diffuse side illumination device for inspecting side surfaces of the stent-like object. An apparatus for acquiring images of the stent-like object including at least one microscope objective lens and at least one camera is also provided.

### TECHNICAL FIELD

The present disclosure relates to a device for inspecting and analysing stent-like objects. More specifically, it refers to a device for optically inspecting and analysing at least one portion of a surface of a stent-like object and for determining at least its critical dimensions, edge roundness and surface defects. A method for optically inspecting and analysing stent-like objects is also disclosed herein.

Both the present device and method are capable of providing the operator with information useful for example for characterizing a stent-like object. The present device and method are intended to assist the operator in order to make decisions about whether the stent-like object should be accepted or rejected according to requirements.

### BACKGROUND

In many applications the walls, such as the inner, outer and/or side surfaces of precision tubular components are often required to be examined and/or inspected in order to detect of identify defects therein. In many specific applications, inspection should be performed without contact, such as through the use of optical means.

Tubular components will be referred hereinafter in general to as stent-like objects. Examples of stent-like objects that are required to be inspected are medical devices such as stents. The present device and method can be however also used for examining and/or inspecting many other tubular components for different applications.

Stents are small, hollow cylindrical bodies made from a mesh structure of metal that are specifically designed to be used for example in the treatment of cardiovascular conditions to temporarily hold a natural conduit open in order to allow access for surgery or to be inserted into a natural passage or conduit in the body to prevent or counteract a disease-induced flow constriction. The mesh structure of the stents defines radially expandable struts. Struts are interconnected by connecting elements such that lateral openings or gaps are formed between adjacent struts. The struts and the connecting elements thus form a tubular stent body having an outer surface to be in contact with a tissue, an inner surface and a side surface. Stents may be manufactured with a variety of sizes according to their particular application. As stated above, stents may also be coated with drugs in order to aid in the treatment of a disease or condition.

Stents are critical elements. They are to be used in areas of the human body such as areas of blood flow. Inspection of stents is therefore highly important. Their surfaces are required to be inspected carefully and accurately in order to identify all defects, for example small imperfections, such that the stent can be rejected if the defect size has been found to be above a given threshold. Inspection must be ensured that only an extremely high quality stent is accepted for its use in the human body. If a defect is not detected through inspection, a failure in the function of the stent may occur which may cause severe complications in the human body. In addition, chemical coated stents always require having their struts without unacceptable defects for a consistent and even distribution of the drug on their struts.

Inspection of stents is a process that is usually carried out manually. This is performed by skilled operators with the assistance of conventional optical magnification tools. However, this involves processes for quality control of the stents that are slow, labour-intensive and expensive. In addition, with manual processes, inspection is subject to human error due to a number of reasons, such as fatigue. For these reasons, manual inspection represents the main bottleneck and the highest cost in the manufacturing process of a stent

Alternatively, inspection of stents have been performed automatically. This is carried out through inspection systems that check the stents for potential defects, classify the defects that are found and prompt the operator that a particular stent that is being inspected is accepted or rejected.

For example, document U.S. Pat. No. 8,311,312 discloses a computer based method for inspecting a stent. The method comprises acquiring images of a portion of the stent, finding a defect in said portion of the stent by computer analysis of the acquired images, retrieving samples of acceptable and unacceptable defects from previously inspected polymeric stents, and comparing the defect found to said acceptable and unacceptable defects and deciding whether to accept, reject or manually inspect the stent.

Document U.S. Pat. No. 8,081,307 discloses a method for inspecting stents. It comprises creating an image of the stent, analysing the image obtained by masking out a strut of the stent in the image, and identifying a defect associated with a feature remaining in said image after the masking out of the strut of the stent. Defects are determined by identifying deviations in measured values of width, height, length, etc. of individual struts in the image.

Document U.S. Pat. No. 8,237,789 discloses a device for automatic illumination and inspection of stents. The device comprises means for holding the stents, an electronic camera, a lens, a computer-based electronic imaging system, and means for illuminating the surface of the stent. The stent illumination means comprise a ring light for creating dark field illumination means and transillumination means to form an image of the stent as a dark object against a bright background. In the device disclosed in this document, the surface of the stent is illuminated from the top through said dark field illumination based on grazing illumination causing specular reflections from surface defects.

The above devices have the main disadvantage that they do not provide the operator with extensive information on defects on the surface of the objects. This results, for example, in that a defect may be detected by the operator so that the object that has been inspected is rejected while the defect is actually within an acceptable threshold.

It has been found that the most reliable system to ensure the highest quality of a stent is a combination of optical systems with a skilled operator who ultimately should decide whether the stent that is being inspected is to be accepted or rejected based on the information provided by the inspection system.

Therefore, there is still the need for a device and a method for inspecting stent-like objects which allow accurate measurements of critical dimensions of stent-like objects to be taken and which is capable of providing the operator with useful information for making decisions on whether to accept or reject the stent-like object that has been inspected.

### SUMMARY

A device for optically inspecting and analysing at least one portion of at least inner and outer surfaces of stent-like objects and determining at least their critical dimensions, edge roundness and surface defects, the device comprising an apparatus for holding and positioning at least one stent-like object and a unit for illuminating said at least inner and outer surfaces of the stent-like object, wherein it further comprises an apparatus for acquiring images of the stent-like object, said image acquiring apparatus comprising at least one microscope objective lens and at least one camera, and wherein the unit for illuminating the stent-like object comprises at least a wide field epi illumination device coaxial with respect to the optical axis of the microscope objective lens, and a diffuse back illumination device, whereby the wide field epi coaxial illumination device and the diffuse back illumination device are adapted for illuminating the stent-like object simultaneously. The present device is also suitable for determining critical dimensions, edge roundness and surface defects of stent-like objects with high degree of accuracy and reliability.

A method is also disclosed herein for optically inspecting and analysing stent-like objects. The method comprises the steps of:
positioning the stent-like object relative to the illumination unit such that at least one portion of a surface of the stent-like object can be illuminated by said illumination unit and focused by image acquiring apparatus; wherein it further comprises the steps of:
   illuminating the stent-like object simultaneously by a wide field epi illumination device coaxial with respect to the optical axis of the image acquiring apparatus and a diffuse back illumination device;
   focusing at least one portion of the stent-like object by the image acquiring apparatus;
acquire images of a surface of the stent-like object line by line while rotating the stent-like object around its longitudinal axis such that a focused unrolled section image of the stent-like object is obtained.

The present method consists of a number of steps that can be performed by the above device.

As used herein, a stent-like object is a tubular component such as for example a stent. A particular application of the present device is the inspection of bare metal stents, such as stents made from stainless steel or CoCr alloy, stents made from shape memory materials like Nitinol, stents made from bioabsorbable materials and also drug eluting stents (DES), etc. Other tubular components that can be inspected by the present device are however not ruled out.

Also as used therein, a critical dimension of a stent-like object refers to its lateral dimension. In the particular case of a stent, its critical dimension within the meaning of the present disclosure refers to a lateral dimension of one strut of the stent. A lateral dimension may correspond for example to the thickness of the strut.

In addition, and also within the meaning of the present disclosure, an outer surface or outer wall of a stent-like object may be defined as a surface of the stent-like object lying in an upper horizontal plane that is substantially perpendicular to the optical axis of the microscope objective lens when said optical axis crosses the longitudinal axis of the stent-like object.

Within the meaning of the present disclosure, an inner surface or inner wall of a stent-like object may be defined in the same way as a surface of the stent-like object lying in a lower horizontal plane that is substantially parallel to the above mentioned upper horizontal plane and substantially perpendicular to the optical axis of the microscope objective lens when said optical axis crosses the longitudinal axis of the stent-like object. In the particular case of stents, the inner surface is the surface which, in use, is internal to the body of the stent.

A side surface or side wall of a stent-like object is a surface substantially perpendicular to the above mentioned upper and lower horizontal planes, substantially parallel to the optical axis of the microscope objective lens when said optical axis crosses the longitudinal axis of the stent-like object.

The present device operates without any mechanical contact with the surface of the stent-like object that is being inspected. Both the present device and method rely on the use of optical techniques.

The present device comprises an arrangement for holding and positioning at least one stent-like object. The holding and positioning arrangement may preferably be of the rotary type, that is, they are adapted for rotatably holding and positioning the stent-like object. In other words, the holding and positioning arrangement is suitable for holding at least one stent-like object and positioning it such as it can be rotated, preferably around its longitudinal axis.

In a general example of the holding and positioning arrangement, it may comprise for example first and second rotatable rollers. It is preferred that both rollers are made of a metal core with a high precision outer surface coating. The rollers may be arranged at least substantially parallel to each other and separated from each other by a given distance. The rollers are adapted to be rotated in the same direction to each other along their respective longitudinal axis. A suitable drive arrangement may be provided to rotate the rollers in order to rotate the stent-like object for inspection.

In some implementations of the device, the stent-like object could be placed directly resting on the high precision surfaces of the above mentioned first and second rollers such that rotation of the rollers results in rotation of the stent-like object. However, in a most preferred example, the holding and positioning arrangement comprises, in addition to said first and second rotatable rollers, a third roller that is freely rotatably supported on said first and second rollers. The third roller may be made similar to the first and second rollers, that is, of a metal core with a high precision outer surface coating. However, the third roller may be different in diameter than the first and second rollers. In this particular implementation of the holding and positioning arrangement, a tube member is also provided attached to, connected with, fitted to or integral with the third roller. This tube member is arranged protruding concentrically outward from the third roller. The tube member may be for example a capillary tube. In general, it may be a thin walled tube made of glass or any other suitable material such as the light is allowed to pass through. The outer surface of such tube member is adapted, i.e. sized, for receiving the stent-like object around it.

In this preferred example of the holding and positioning arrangement surface imperfections of the stent-like object, for example, caused when it is handled, are allowed to be simply and reliably accommodated for inspection while avoiding undesired movements such as micro jumps when the stent-like object is rotated around the rollers of the holding and positioning arrangement.

In any case, the first and second rollers of the holding and positioning arrangement are mounted on a displaceable table. The displaceable table is adapted so that it can be moved on a horizontal plane for a proper positioning of the stent-like object.

The arrangement for holding and positioning the stent-like object forms a high precision electromechanical module or rolling stage for loading and unloading stent-like objects in the device as well as for arranging it in a given longitudinal, radial and angular positioning with a high overall accuracy which may be of the order of 1 micron or less.

The present device further comprises an apparatus for acquiring images of the stent-like object that is being inspected. Said image acquiring apparatus comprises at least one microscope objective lens and at least one camera. It is preferred that the camera of said image acquiring apparatus is a high-resolution camera. Such high-resolution camera is adapted for operating based on a single row of pixel sensors instead of on a matrix of pixel sensors, that is, it is adapted for operating as a line scan camera.

A unit for illuminating the inner and outer surfaces of the stent-like object are provided. According to an important feature, the unit for illuminating the inner and outer surfaces of the stent-like object comprises at least two types of illumination devices: an epi illumination device and a back illumination device. More specifically, they comprise a wide field epi illumination device and a diffuse back illumination device.

The wide field epi illumination device is adapted for illuminating the stent-like object such that light is directed substantially perpendicularly to the inner and outer surfaces (inner and outer walls) of the stent-like object, that is, substantially vertically. In the present device, the wide field epi illumination device is coaxial with respect to the optical axis of the above mentioned microscope objective lens. This means that the light reaches the inner and outer surfaces (inner and outer walls) of the stent-like object through the optical axis of the microscope objective lens.

Therefore, in the present device the surfaces of the stent-like object are illuminated by means of a combination of two different illumination devices (epi and back illumination devices). Such dual illumination devices are adapted for illuminating the stent-like object simultaneously when the device is in use. Simultaneous illumination of surfaces or walls of the stent-like object through different illumination devices is an important feature of the present device. It involves both epi and back illumination devices that act at the same time when the stent-like object is being inspected by the present device.

At least one of the wide field epi coaxial illumination devices and the diffuse back illumination devices comprises at least one LED. In a non limiting example, the diffuse back illumination device may be for example a 10 cm long green LED bar having a diffusor on a front portion thereof. The diffusor is adapted to cause every point of the light emitting surface to emit light in all directions. In general, it is preferred that the back illumination devices comprise a high intensity linear diffuse LED illuminator.

The above mentioned illumination unit is suitable for inspecting the inner and outer walls of struts in a stent-like object allowing at least its critical dimensions, edge roundness and surface defects to be accurately analysed. In the specific case of stents, the possibility of inspecting edge roundness and surface defects of the inner wall of struts is highly advantageous since it reduces or removes the risk of damaging a balloon of a stent with surface defects when expanded and spread into the inner walls of its struts.

In some implementations of the present device, the unit for illuminating the stent-like object may further comprise a diffuse side illumination device. Such illumination device is suitable for illuminating side surfaces or side walls of the stent-like object.

Therefore, there could be advantageous implementations where the unit for illuminating the inner and outer surfaces of the stent-like object comprises three types of illumination devices: epi, back and side illumination devices.

Specifically, the above mentioned diffuse side illumination device is suitable for inspecting the side surfaces, that is the side walls, of struts in a stent-like object and for analysing at least its critical dimensions, edge roundness and surface defects. As stated above, a side surface or side wall of a stent-like object is a surface substantially parallel to the optical axis of the microscope objective lens when the optical axis crosses the longitudinal axis of the stent-like object. Again, the possibility of inspecting edge roundness and surface defects of the side wall of struts in the specific case of stents is highly advantageous since it reduces or removes the risk of damaging a balloon of a stent with surface defects when expanded and spread into the side walls of its struts.

A sensor head is provided comprising the above mentioned epi illumination device. The sensor head further comprises lenses, collimators, magnification optics, and elements with metrological capabilities. The sensor head is capable of providing 2D imaging capabilities to obtain high-speed focused colour images of the outer, inner and side surfaces of the stent-like object that is being inspected.

However the sensor head is also capable of providing 3D imaging capabilities through two different examples.

In a first example, the 3D imaging capabilities can be obtained with a sensor head provided with a vertical scanning stage device for moving the sensor head vertically, standard microscope objective lens and an arrangement for projecting at least one structured illumination pattern onto a surface of the stent-like object. The structured illumination pattern is suitable for determining the topography of the surface of the stent-like object and/or the thickness of the coating in said surface of the stent-like object.

In a second example, the 3D imaging capabilities can be obtained with a sensor head provided with said vertical scanning stage device and interferometric microscope objective lens. The interferometric lens is suitable for determining the topography and/or the roughness of the surface of the stent-like object, and/or the thickness of the coating of the surface of the stent-like object.

In some implementations, an electronic image-processing system may be also provided. Said electronic image-processing system may be capable of analysing images that are acquired by the above mentioned image acquiring apparatus.

The inspection process is controlled by a suitable software application capable of displaying data analysis to the operator according to the inspection and analysis carried out on stent-like objects. This software application is operated through a suitable graphic user interface that allows the operator to carry out required measurements on the stent-like objects that have been inspected. This allows the operator performing subsequent analysis of data collected through inspection and to take final decisions about the acceptance or the rejection of the inspected stent-like object. In connection with the software application, the present device provides a manual mode of operation and an assisted mode of operation.

The manual mode of operation is used in product research and development for inspection of stent-like objects. The operator in this mode is allowed to perform illumination and focus adjustments, live image observation, measurement of critical dimensions in the live image, 2D acquisition and image analysis (as a screenshot, extended focus, field of view or unrolled section), 3D acquisition and analysis (topography, roughness, measurement of the thickness of the coating), obtaining log files, reports of inspection, etc. The manual mode of operation provides the operator with a specialized metrology to analyse the results obtained in the different stages of development and manufacturing of a stent-like object (for example, checking specifications of the original object, laser cutting, electropolishing, heat treatment, coating, etc.), fine tuning of production equipment and process optimization and settings of tolerances and identification of defects that will be used later in the assisted mode for the inspection of stent-like objects.

The assisted mode of operation is used primarily in control of production, but also in process control and optimization. In this mode, the device automatically performs measurements, analyses the results, registers files, generates reports of findings and informs the operator as soon as said data become available. Online measurements on relevant aspects of the stent-like object may be performed in this mode by dividing the struts into sections. The operator is provided with the results of such measurements as well as information according to defects, etc. The operator can then decide whether the stent-like object is to be accepted or rejected. The operator can also skip the measurement. In any case, the device does not make decisions.

With the above described device an optimal solution for the inspection of stent-like objects is provided. This has been shown to be highly efficient either for research and development and product development stages or in intermediate or final inspection and quality control process of stent-like objects.

The present device provides detailed information on defects of the surface of stent-like objects, specifically information on defects in inner and outer surfaces, that is, inner and outer walls of the struts, as well as on defects in the side surfaces or side walls of the struts, and on the quality of the edges of the struts (strut roundness). The present device is also capable of providing detailed information on strut roundness which is an important advantage of the present device over prior art solutions where a partial inspection is carried out, performed only in specific areas in the outermost portions of the struts.

At the end of the inspection process of each stent the present device is capable of generating data on the complete sequence of operations performed, the results of the measures and the decision taken by the operator from the results provided by the device on the acceptance or rejection of the stent. If the operator deems it necessary, is it possible to retrieve the live image at any position of the stent and request the device to perform additional measures and analysis. In any case, the decision on the acceptance or rejection of the stent-like object is the sole responsibility of the operator.

A method for optically inspecting and analysing stent-like objects is also provided. This method may be carried out through the above described device.

According to said method, at least one stent-like object may be loaded by the operator on a rotatably holding and positioning apparatus in an inspection device such as the one described above. Then, the operator enters inspection data such as batch ID, stent-like object ID, operation, stent-like object model and analysis settings (critical dimensions, edges, defects).

The stent-like object is then moved or positioned relative to the illumination unit of the device. The stent-like object is thus positioned such that at least one portion in a surface or wall, for example an inner or an outer surface, of the stent-like object can be appropriately illuminated by said illumination unit and focused by image acquiring apparatus.

In this specific position, the stent-like object is illuminated simultaneously by a wide field epi coaxial illumination means device and by a diffuse back illumination device. At least one portion of the stent-like object is focused by the image acquiring apparatus.

The stent-like object is rotated around its longitudinal axis through said holding and positioning apparatus while images of the surfaces of the stent-like object are acquired line by line by the high resolution line scan camera. This results in that inner and outer focused unrolled section images of the stent-like object are obtained and displayed to the operator.

In the above mentioned implementation of the device in which a diffuse side illumination device is provided, the present method may include positioning the stent-like object relative to the illumination unit such that the optical axis of the wide field epi coaxial illumination device and the image acquiring apparatus (the optical axis is the same) is moved laterally by a distance or lateral displacement Δy to the longitudinal axis of the stent-like object.

The stent-like object is also positioned relative to the image acquiring apparatus such that a side surface of the stent-like object is displaced vertically by a distance or vertical displacement Δz until a focus position is reached. In this specific position of the stent-like object, a central point of its side surface is focused and simultaneously illuminated by a diffuse side illumination device and a diffuse back illumination device. Then, the stent-like object is rotated around its longitudinal axis by the holding and positioning apparatus so that images of a side surface or side wall of the stent-like object are acquired line by line. An unrolled side surface image of the stent-like object is thus obtained.

The above mentioned lateral displacement Δy of the optical axis to the longitudinal axis of stent-like object being inspected may be determined through the formula [Δz=A·Sin α], and the vertical displacement Δz of the vertical focus position may be determined through the formula [Δz=A (1−cos α)]. In both formulae, a is the angle between the optical axis and a line passing through the longitudinal axis of the stent-like object and the central point and A is the distance from the longitudinal axis of the stent-like object to the central point. In other words, said distance A could be also determined by subtracting half the value of the critical dimension of the side surface of the stent-like object from the outer radius thereof. It is preferred that said angle α lies in the range of about 30° to about 50°, with 40° being most preferred as being the optimal value for the shallower depth of field and the larger side wall dimension on the unrolled side surface image.

Through the present method the operator is provided with information about critical dimensions of the surface of the stent-like object, and/or edge roundness of the surface of the stent-like object, and/or surface defects of the surface of the stent-like object from the acquired images of the stent-like object. Examples of critical dimensions of the stent-like object may be its thickness, sizes of the struts of the stent-like object and, in general, geometrical dimensions of struts of stent-like objects.

The present device and method thus provide capabilities for performing a dimensional control, that is, for accurately measuring the geometry of stent-like objects, for detecting defects such as fractures, scratches, bites, pollution, areas with lack of coating, etc. in the inner, outer and side surfaces or side walls of the stent-like object. The present device and method further provide capabilities for measuring 3D topographies of defects, roughness and thickness of coatings of inner, outer and side surfaces or side walls of the stent-like object.

In addition to the foregoing, the present device and the present method have been shown to be significantly faster than the devices and methods currently available in the prior art. For example, the present device and the present method have been shown to be 5 minutes faster than known prior art devices and methods for a standard coronary stent. In addition, due the simple configuration of the present device, it has been shown to be a simple and cost effective solution.

Additional objects, advantages and features of implementations of the present device and method for optically inspecting and analysing stent-like objects will become apparent to those skilled in the art upon examination of the description, or may be learned by practice thereof.

### BRIEF DESCRIPTION OF THE DRAWINGS

Particular examples of the present device and method for optically inspecting and analysing stent-like objects will be described in the following by way of non-limiting examples. The description is given with reference to the appended drawings.

In said drawings:

FIG. 1 is a diagrammatic general view of one example of the present device for optically inspecting and analysing stent-like objects;

FIG. 2 is a diagrammatical view of one example of the present device for optically inspecting and analysing stent-like objects showing how the present method is carried out when an epi illumination device and back illumination device are acting simultaneously;

FIG. 3 is a diagrammatical view of one example of the present device for optically inspecting and analysing stent-like objects showing how the present method is carried out when an epi illumination device, back illumination device and side illumination device are used;

FIG. 4 is a diagrammatical top view of one preferred example of the holding and positioning apparatus of the stent; and

FIG. 5 is a diagrammatical elevational view of the preferred example of the holding and positioning device of the stent shown in FIG. 4.

### DETAILED DESCRIPTION OF EXAMPLES

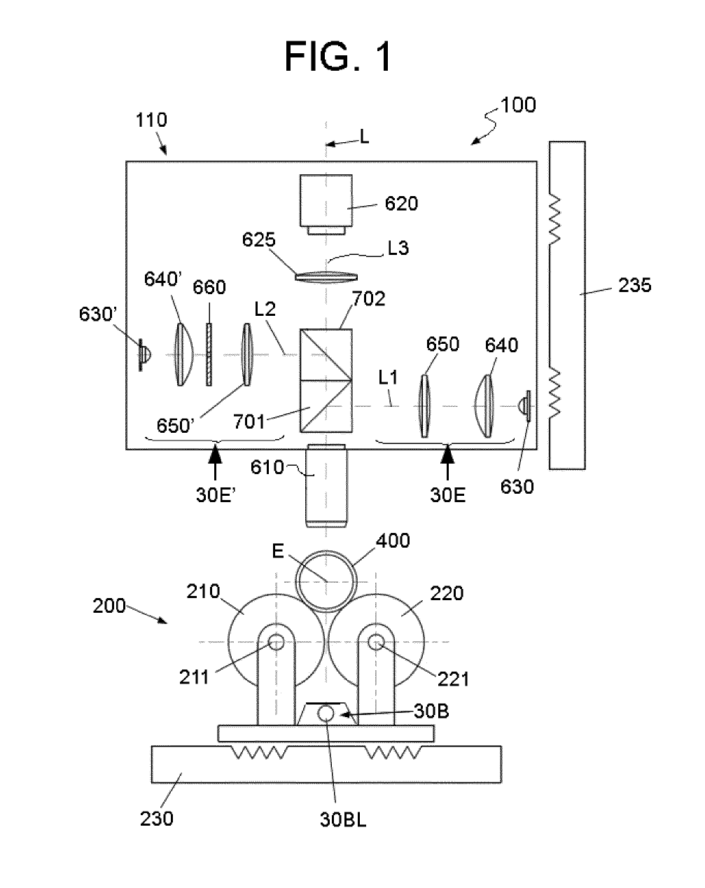

According to the non-limiting examples shown in FIGS. 1-5 of the drawings, a device for optically inspecting and analysing stent-like objects will be described hereinbelow. The device and method described according to the specific examples shown are for inspecting and analysing stents 400. A stent 400 is therefore used herein as a non-limiting example of a stent-like object.

FIG. 1 shows a diagrammatic general example of the device 100. In this example, the present device 100 comprises a sensor head 110 that is capable of providing both 2D and 3D imaging capabilities.

The sensor head 110 includes an illumination unit that is described in detail below. The illumination unit in the sensor head 110 is adapted to project light into portions of the outer surfaces O and portions of the inner surfaces I of the stent 400.

The sensor head 110 further includes an apparatus for acquiring images of portions of the surfaces O, I of the stent 400. In the particular example shown, the image acquiring apparatus includes a microscope objective lens 610.

The sensor head 110 is capable of providing 3D imaging capabilities through two different examples.

In a first example the sensor head 110 is provided with a vertical scanning stage device 235 for moving the sensor head 110 vertically in order to obtain images of the stent 400 in different planes. The sensor head 110 is thus capable of obtaining high-speed focused color images of the outer surface O, the inner surface I and the side surface S of the stent 400. In this example, the sensor head 110 is also provided with standard microscope objective lens 610 and an arrangement 30E′ for projecting a structured illumination pattern 660 onto a surface I, O of the stent 400. Such structured illumination pattern 600 is suitable for determining the topography of the outer surface O, the inner surface I and the side surfaces of the stent 400 and/or the thickness of the coating in said surfaces I, O, S of the stent 400. The structured illumination arrangement 30E′ comprises a light source, which in the example shown includes a LED 630′, a first lens, which in the example shown is a collimator 640′ for concentrating the light from the LED 630′, a second lens 650′, a structured illumination pattern 660, and a beam splitter cube 702.

In a second example, the 3D imaging capabilities can be obtained with a sensor head 110 provided with the vertical scanning stage device 235 for moving the sensor head 110 vertically. In contrast to the previous example, the sensor head 110 now employs an interferometric microscope objective lens. The interferometric microscope objective lens is suitable for determining the topography and/or the roughness of surfaces I, O S of the stent 400, and/or the thickness of the coating of the surfaces I, O S of the stent 400. No structured illumination pattern projecting arrangement 30E′ is required in this specific example.

In all cases, a high-resolution line scan camera 620 is provided in the sensor head 110. Adjacent to the line scan camera 620 is a field lens 625 for changing the size of the image.

The illumination unit comprises a wide field epi illumination device 30E. The wide field epi illumination device 30E is adapted for directing light substantially vertically from the top of the device 100 and coaxially with respect to the optical axis L of the microscope objective lens 610.

For this purpose, the wide field epi illumination device 30E comprises a light source, which in the particular example shown includes a LED 630, a first lens, which in the example shown is a collimator 640 for concentrating the light from the LED 630, a second lens 650 and a beam splitter cube 701.

The beam splitter cubes 701, 702 are adapted for coupling the illumination device 30E, 30E′ with the image acquiring device.

The structured illumination device 30E′ allows the topography of the inner surface I and the outer surface O of the stent 400 and/or thickness of the coating in said inner and outer surfaces I, O of the stent 400 to be determined. It is to be noted that the wide field epi illumination device 30E and the structured illumination device 30E′ are operated alternatively, that is, in use, when the wide field epi illumination device 30E is activated, the arrangement 30E′ for projecting a structured illumination pattern 660 is not activated and vice versa.

According to the above, two illumination branches L1, L2 and an imaging branch L3 are defined in the sensor head 110.

The illumination unit of the device 100 further comprises a diffuse back illumination device 30B as shown in FIGS. 1, 2, 3 and 5 of the drawings. Said back illumination device 30B is adapted for directing light substantially vertically from the bottom of the device 100. The diffuse back illumination device 30B in the present implementation comprises a high intensity linear diffuse LED illuminator having a 10 cm long green LED bar 30BL and a diffusor arranged on a front portion. The diffusor is adapted to cause every point of the light emitting surface in the LED 30BL to emit light in all directions to the stent 400.

The device 100 further comprises a high precision electromechanical module or rolling stage. It includes an apparatus 200 for rotatably holding and positioning a stent 400 to be inspected.

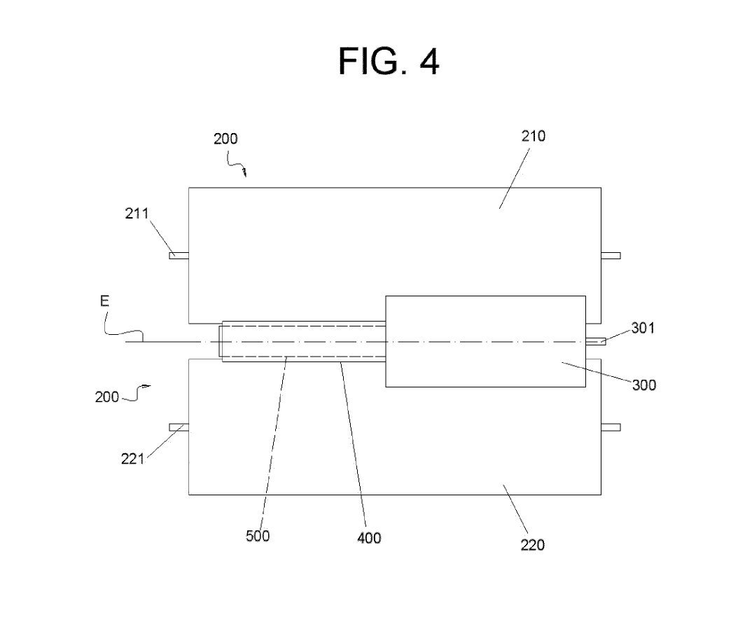

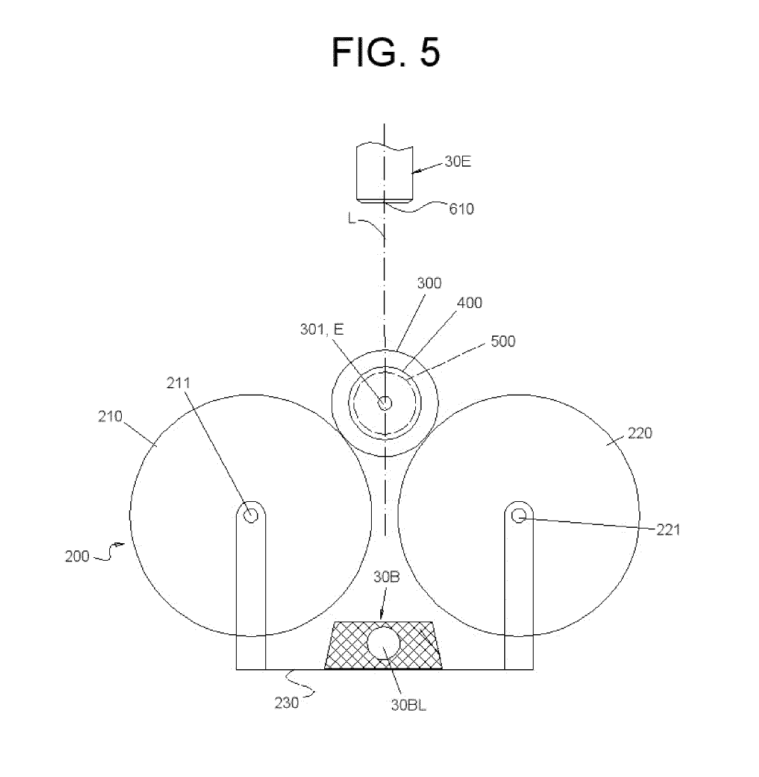

The holding and positioning apparatus 200, in one preferred example, of which has been shown in FIGS. 4 and 5 of the drawings, comprises a first roller 210 and a second roller 220. The first and second rollers 210, 220 are cylindrical bodies made of a metal core with a high precision outer surface coating.

The rollers 210, 220 are mounted on a horizontal support table 230. The horizontal support table 230 can be moved on a horizontal plane. The rollers 210, 220 are mounted on the support table 230 with their respective longitudinal axis 211, 221 arranged substantially parallel to each other. The rollers 210, 220 are arranged separated from each other by a distance suitable for receiving the stent 400 to be inspected between them, with the stent 400 resting freely on the high precision surfaces of the rollers 210, 220. The rollers 210, 220 are mounted on the support table 230 such that they can be rotated in the same direction to each other through a suitable drive, not shown, around their respective longitudinal axis 211, 221. Rotation of the rollers 210, 220 around their respective longitudinal axis 211, 221 by said drive causes the stent 400 to be rotated around its longitudinal axis E.

FIGS. 4 and 5 show a preferred example of the holding and positioning apparatus 200. In this case, the holding and positioning apparatus 200 further comprises a third roller 300 in addition to the above mentioned rollers 210, 220. The third roller 300 of the holding and positioning apparatus 200 is supported on the first and second rollers 210, 220 such that it can be freely rotated. The third roller 300 can be rotated by the first and second rollers 210, 220 around its longitudinal axis 301.

A tube member 500 is provided protruding concentrically outward from the third roller 300. Such tube member 500 is a thin walled glass capillary tube 500 that is suitably designed such as the light is allowed to pass through. For this purpose, in this case, the tube member 500 is made of a transparent material. The capillary tube member 500 is suitably sized for receiving the stent 400 in a way that the stent 400 can be inserted around it surrounding the outer surface of the tube member 500.

As the first and second rollers 210, 220 are rotated by the drive, the third roller 300 placed thereon is caused to be rotated. Consequently, the tube member 500 together with the stent 400 are also caused to be rotated. An accurate rotation of the stent 400 is allowed to be performed irrespective of any imperfections on the struts of the stent 400 that is being inspected.

The above example of the holding and positioning apparatus 200 allows the stent 400 to be loaded and unloaded easily by the operator as well as to be placed in a suitable given longitudinal, radial and angular positions with an extremely high overall accuracy, which may be of the order of 1 micron or even less.

Finally, in the present implementation of the device 100, the illumination unit further comprises a side illumination device 30S. Such side illumination device 30S is adapted for directing light to at least portions of the side surfaces or side walls S of the stent 400.

As defined above, the side surfaces or side walls S are surfaces of the stent 400 substantially parallel to the optical axis L of the wide field epi coaxial illumination device 30E and the image acquiring apparatus when said optical axis L crosses the longitudinal axis E of the stent E.

As with the outer surfaces O and the inner surfaces I of the stent 400, the side illumination device 30S allows at least portions of the side surfaces S of the stent 400 to be inspected, and critical dimensions CD of the strut to be analysed. In addition, information about edge roundness and surface defects in such portions of the side surfaces S of the stent 400 is also provided.

At least the wide field epi coaxial illumination device 30E and the diffuse back illumination device 30B are combined with each other such that, in use, they are activated simultaneously for illuminating portions of the outer surfaces O and the inner surfaces I of the stent 400. The dual combined simultaneous illumination of the surfaces or walls I, O of struts of the stent allows said inspection information to be accurately obtained.

In the specific example shown, an electronic image-processing system is provided. This electronic image-processing system is capable of analysing the images that are acquired by the image acquiring apparatus. The operator can carry out measurements on the stent 400 that is being inspected so that subsequent analysis of collected data can be carried out in order to take final decisions about the acceptance or the rejection of the inspected stent 400.

The inspection process performed by the device 100 is controlled by a software application. This software application, through a corresponding graphic user interface, provides data analysis to the operator.

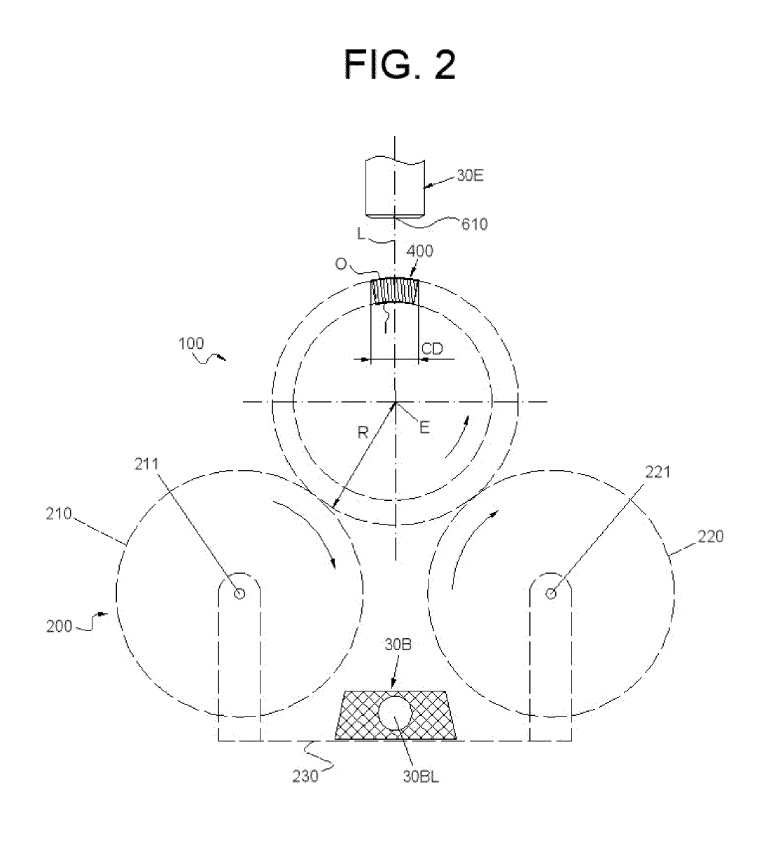

For inspecting and analysing a stent 400 through the present method using the above described device 100, the operator loads a stent 400 on the holding and positioning device 200 of the device 100. When using the preferred example of the holding and positioning device 200, this is carried out by carefully fitting the stent 400 around the tube member 500 of the third roller 300 and placing the third roller 300 onto the first and second rollers 210, 220. The stent 400 is appropriately positioned by the horizontal support table 230, the vertical scanning stage device 235 and the rollers 210, 220, 300 such that one portion of the inner surface I or the outer surface O of the stent 400 is illuminated by the wide field epi illumination device 30E and the diffuse back illumination device 30B and such that said portion of the inner surface I or the outer surface O of the stent 400 is suitably focused by the image acquiring apparatus. This is diagrammatically shown in FIG. 2.

Once the stent 400 has been properly positioned relative to the illumination unit 30E, 30B and the image acquiring apparatus, the stent 400 is illuminated simultaneously by the wide field epi coaxial illumination device 30E and by the diffuse back illumination device 30B and focused by the image acquiring apparatus. Then, the drive causes the rollers 210, 220, and consequently the third roller 300 with the tube member 500, to be rotated so that the stent 400 that is fitted around the tube member 500 is also rotated around its longitudinal axis E. As shown in FIGS. 4 and 5, the longitudinal axis E of the stent 400 coincides with the longitudinal axis 301 of the third roller 300. As the stent 400 is rotated around its longitudinal axis E, images of the inner surfaces I and the outer surfaces O of the stent 400 are acquired line by line by the high resolution line scan camera 620. Inner and outer focused unrolled section images of the stent 400 are thus obtained which can be displayed to the operator through a display monitor.

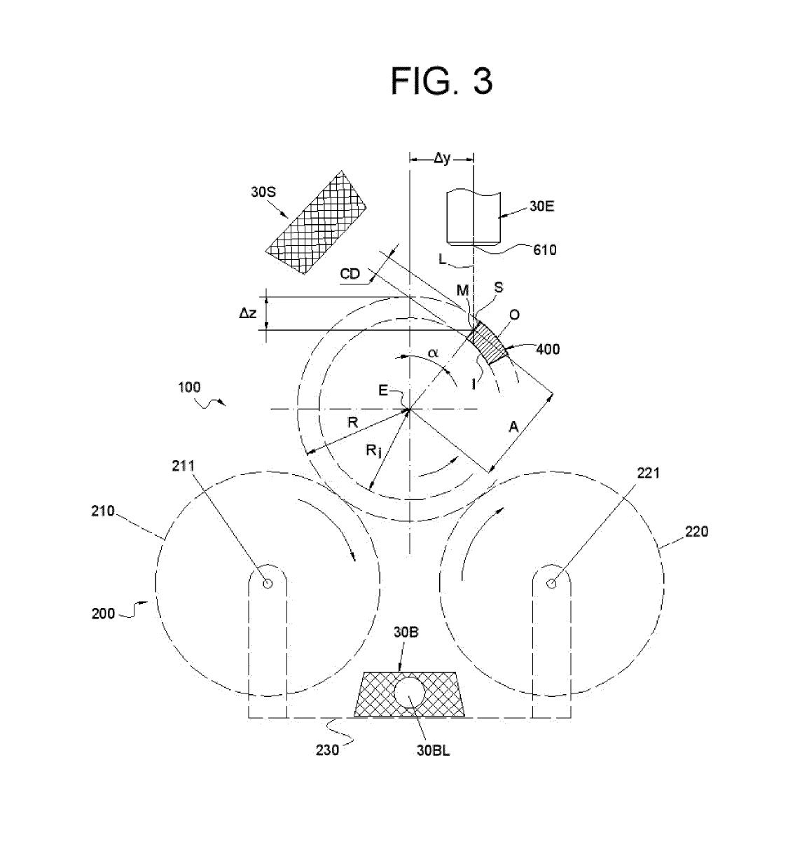

For inspecting at least one portion of the side surfaces S or side walls of the stent 400, the stent 400 is loaded on the holding and positioning apparatus 200 by the operator as stated above such that the stent 400 is positioned in a way that the optical axis L of the wide field epi coaxial illumination device 30E and the image acquiring apparatus is displaced by a determined lateral distance or displacement Δy. Said lateral displacement Δy is defined by a horizontal distance of the optical axis L to the longitudinal axis E of the stent 400 as shown in FIG. 3. It may be determined through the formula: Δy=A·Sin α. A relative vertical displacement Δz of the stent 400 is carried out until the focus position is reached. Said vertical displacement Δz is defined by a vertical distance travelled by a position of the side surface S of the stent 400 as shown in FIG. 3. It may be determined through the formula: Δz=A (1−cos α).

In both cases a is the angle between the optical axis L and a line passing through the longitudinal axis E of the stent 400 and a central point M of the side surface S of the stent 400. In a preferred example the angle α lies in the range of about 30° to about 50° and most preferably the angle α is of about 40°. A is the distance from the longitudinal axis E of stent 400 to the central point M of the side surface S of the stent 400, as shown in FIG. 3 of the drawings. The distance A may be of course defined through the outer radius R of the stent 400 or through the inner radius R₁ of the stent 400. In the first case, the distance A can be determined through the formula:

$$A = R - \frac{CD}{2}$$

while in the second case, the distance A can be determined through the formula

$$A = {R}_{i} + \frac{CD}{2}$$

wherein, CD is the critical dimension of the side surfaces or side walls S of the stent 400 that in the present example corresponds to its lateral dimension, i.e. its thickness, and R₁ is the inner diameter of the stent 400 as stated above.

The central point M of the side surface S of the stent 400 is then focused by the image acquiring apparatus. The side surface S of the stent 400 is simultaneously illuminated by the diffuse side illumination device 30S and the diffuse back illumination device 30B. Then, the drive causes the rollers 210, 220, 300 to rotate so that the stent 400 fitted around the tube member 500 is rotated around its longitudinal axis E. As the stent 400 is rotated, images of its side surface S are acquired line by line by the high resolution line scan camera 620. This results in that side unrolled section images of the stent 400 are obtained which can be also displayed to the operator through the display monitor.

From the acquired images of the stent 400 information is provided, e.g. displayed, to the operator about the critical dimension CD of the inner, outer and side surfaces I, O, S of the stent 400, the edge roundness of the struts of the stent 400, surface defects in surfaces I, O, S of the stent 400, etc. Ultimately, the operator can make the decision on the acceptance or rejection of the stent 400 from said information.

Although only a number of particular examples of the present device and method have been disclosed herein, it will be understood by those skilled in the art that other alternative examples and/or uses as well as obvious modifications and equivalents are possible. The present disclosure covers all possible combinations of the particular examples described herein.

The scope of the present disclosure should not be limited by particular examples, but should be determined only by a fair reading of the claims that follow.

Reference signs related to drawings and placed in parentheses in a claim are solely for attempting to increase the intelligibility of that claim. Such reference signs therefore shall not be construed as limiting the scope of the claim.

1. A device for optically inspecting and analysing at least one portion of at least inner and outer surfaces of stent-like objects and determining at least their critical dimensions, edge roundness and surface defects, the device comprising:
an apparatus for holding and positioning the at least one stent-like object and a unit for illuminating the at least inner and outer surfaces of the stent-like object, wherein the device further comprises
an apparatus for acquiring images of the stent-like object, the image acquiring apparatus comprising at least one microscope objective lens and at least one camera, and wherein
the unit for illuminating the stent-like object comprises at least a wide field epi illumination device coaxial with respect to an optical axis of the microscope objective lens, and a diffuse back illumination device, whereby the wide field epi coaxial illumination device and the diffuse back illumination device are adapted for illuminating the stent-like object simultaneously.

2. The device of claim 1, wherein the unit for illuminating the stent-like object further comprise a diffuse side illumination device suitable for inspecting the side surfaces of the stent-like object and analysing at least its critical dimensions, edge roundness and surface defects.

3. The device of claim 1, wherein the device further comprises an electronic image-processing system capable of analysing images acquired by the image acquiring apparatus.

4. The device of claim 1, wherein the device further includes an apparatus for projecting at least one structured illumination pattern onto a surface of the stent-like object suitable for determining at least one of the topography of the surface and the thickness of the coating in the surface.

5. The device of claim 1, wherein the microscope objective lens is an interferometric lens suitable for determining at least one of the topography of the surface of the stent-like object the roughness of the surface of the stent-like object and the thickness of the coating of the surface of the stent-like object.

6. The device of claim 4, wherein the device further includes a vertical scanning device for obtaining a series of images in different planes of the stent-like object.

7. The device of claim 1, wherein the apparatus for holding and positioning the stent-like object is suitable for rotatably holding and positioning the stent-like object.

8. The device of claim 7, wherein the apparatus for holding and positioning the stent-like object comprises first and second rollers arranged at least substantially parallel to each other and adapted to rotate in the same directions as each other, a third roller resting on the first and second rollers and rotatable with the first and second rollers, and a tube member protruding concentrically outward from the third roller and adapted for receiving the stent-like object by surrounding it, with the tube member being made from a material that allows light to pass through it.

9. The device of claim 1, wherein at least one of the wide field epi coaxial illumination device and the diffuse back illumination means device comprises at least one LED.

10. The device of claim 1, wherein the at least one camera of the image acquiring apparatus is adapted for operating as a line scan camera.

11. A method for optically inspecting and analysing a stent-like object, the method comprising the steps of:
positioning the stent-like object relative to an illumination unit such that at least one portion of a surface of the stent-like object can be illuminated by the illumination unit and focused by an image acquiring apparatus;
wherein the method further comprises the steps of:
illuminating the stent-like object simultaneously by a wide field epi illumination device coaxial with respect to an optical axis of the image acquiring apparatus and a diffuse back illumination device;
focusing at least one portion of the stent-like object using the image acquiring apparatus; and
acquiring images of a surface of the stent-like object line by line while rotating the stent-like object around its longitudinal axis such that a focused unrolled section image of the stent-like object is obtained.

12. The method of claim 11, wherein the method includes the steps of:
positioning the stent-like object relative to the illumination unit and the image acquiring apparatus such that the optical axis of the wide field epi coaxial illumination device and the image acquiring apparatus is displaced laterally by a distance to the longitudinal axis of the stent-like object and a side surface of the stent-like object is displaced vertically by a distance;
focusing a central point of the side surface of the stent-like object;
simultaneously illuminating the side surface of the stent-like object by a diffuse side illumination device and a diffuse back illumination device; and
rotating the stent-like object around its longitudinal axis in order to acquire images of the side surface of the stent-like object line by line such that an unrolled side surface image of the stent-like object is obtained.

13. The method of claim 12, wherein the displacement of the optical axis relative to the longitudinal axis of the stent-like object corresponds to the value of a distance from the longitudinal axis of the stent-like object to a central point multiplied by the sine of an angle between the optical axis and a line passing through the longitudinal axis of the stent-like object and the central point, and wherein the displacement of a vertical focus position corresponds to the value of the distance multiplied by one minus the cosine of the angle.

14. The method of claim 13, wherein the angle between the optical axis and a line passing through the longitudinal axis of the stent-like object and the central point is in the range of about 30° to about 50°.

15. The method of claim 11, wherein the method further includes obtaining information about at least one of critical dimensions of the surface of the stent-like object, edge roundness of the surface of the stent-like object, and surface defects of the surface of the stent-like object from the acquired images of the stent-like object.
